(19) United States
(12) Patent Application Publication
(10) Pub. No.: US 2010/0055528 A1
(43) Pub. Date: Mar. 4, 2010

(54) FUEL CELL SYSTEM

(75) Inventors: Eon-Soo Lee, Seoul (KR); Jae-Hyuk Jang, Seoul (KR); Sung-Han Kim, Suwon-si (KR); Hye-Yeon Cha, Yongin-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/355,307

(22) Filed: Jan. 16, 2009

(30) Foreign Application Priority Data
Sep. 4, 2008 (KR) 10-2008-0087339

(51) Int. Cl. H01M 8/00

(52) U.S. Cl. 429/30

(57) ABSTRACT

Disclosed is a fuel cell system. The fuel cell system in accordance with an embodiment of the present invention includes a membrane electrode assembly including a fuel electrode, an air electrode, and an electrolyte layer interposed between the fuel electrode and the air electrode; a separator including a channel that is adjacent to the fuel electrode and is provided for supplying hydrogen to the fuel electrode; a hydrogen supply device supplying hydrogen to the channel; and a relief valve formed on the channel and controlling pressure of the channel.

### CROSS-REFERENCE TO RELATED APPLICATIONS

This application claims the benefit of Korean Patent Application No. 10-2008-0087339, filed with the Korean Intellectual Property Office on Sep. 4, 2008, the disclosure of which is incorporated herein by reference in its entirety.

### BACKGROUND

1. Technical Field

The present invention relates to a fuel cell system.

2. Description of the Related Art

In general, a fuel cell system is a kind of an electricity generation system that causes both a fuel, such as methanol, which contains hydrogen, and oxidizing gas, such as air, to electrochemically react at a gas diffusion electrode, and generates electricity. The fuel cell system is now popular as a clean energy source of the future for solving both the difficulty in obtaining a power source due to the increasing demands for electric power and global environmental problems caused by use of fossil energy.

Much research has been devoted to polymer electrolyte membrane fuel cell as one type of a fuel cell. The polymer electrolyte membrane fuel cell generates water as a reactant. Since the reaction temperature is lower than a boiling point of water, it is common that the reactant is liquefied and discharged. It is a key point that the amount of water is balanced by continuously discharging the reaction product, that is, the water in order to cause the reaction to continue.

Up to now, the water generated in such a manner in most fuel cells is discharged by a forced flow method through excessive supply of fuel gas and air. However, since the forced flow method has low fuel consumption efficiency due to the excessive supply of fuel, it is the best to apply a dead-end channel having a closed end in order to increase the fuel consumption efficiency when fuel is supplied. However, it is difficult to apply the dead-end channel because until now it is troublesome to discharge the reactant, i.e., water, and to solve the pressure loading to the channel.

### SUMMARY

The present invention provides a fuel cell system of a simple structure having a dead-end channel capable of removing water generated in a fuel cell stack having a simple structure and of preventing excessive pressure from being given to the inside of the stack due to supplied hydrogen.

An aspect of the present invention features a fuel cell system. The system in accordance with an embodiment of the present invention can include: a membrane electrode assembly including a fuel electrode, an air electrode, and an electrolyte layer interposed between the fuel electrode and the air electrode; a separator including a channel that is adjacent to the fuel electrode and is provided for supplying hydrogen to the fuel electrode; a hydrogen supply device supplying hydrogen to the channel; and a relief valve formed on the channel and controlling pressure of the channel.

The hydrogen supply device can include: a hydrogen storage tank storing hydrogen; and a manifolder controlling pressure of hydrogen supplied from the hydrogen storage tank. The hydrogen supply device can supply hydrogen to one end of the channel and the other end of the channel, and include a first pipe connected to one end of the channel and a second pipe connected to the other end of the channel.

The relief valve can include a piston that is mechanically opened when the pressure of the channel increases.

### BRIEF DESCRIPTION OF THE DRAWINGS

FIG. 1 is a conceptual diagram showing a fuel cell system according to an embodiment of the present invention.

FIG. 2 is a plan view showing a separator of a fuel cell system according to an embodiment of the present invention.

FIGS. 3 and 4 are conceptual diagrams showing the operation of a relief valve according to an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. In the following description of the present invention, the detailed description of known technologies incorporated herein will be omitted when it may make the subject matter unclear.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, embodiments of a fuel cell system in accordance with the present invention will be described in detail with reference to the accompanying drawings. In description with reference to accompanying drawings, the same reference numerals will be assigned to the same or corresponding elements, and repetitive descriptions thereof will be omitted.

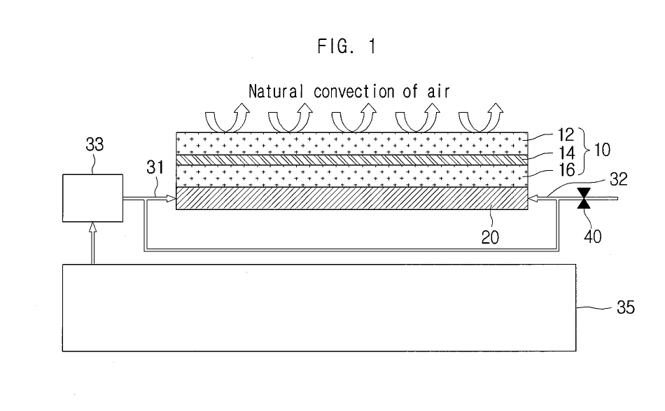

FIG. 1 is a conceptual diagram showing a fuel cell system according to an embodiment of the present invention. In FIG. 1, illustrated are a separator 20, a first pipe 31, a second pipe 32, a manifolder 33, a hydrogen storage tank 35 and a membrane electrode assembly (MEA) including an air electrode 12, an electrolyte layer 14 and a fuel electrode 16.

The basic configuration of a fuel cell is a stack receiving hydrogen and generating energy by decomposing the hydrogen through an oxidation-reduction reaction. Actually, the oxidation-reduction reaction occurs at a membrane electrode assembly 10 (hereinafter, referred to as “MEA”). The MEA 10 has a structure in which an air electrode 12, an electrolyte layer 14 and a fuel electrode 16 are laminated. Hydrogen supplied to the fuel electrode 16 is separated into a hydrogen ion and an electron. The hydrogen ion moves to the air electrode 12 through the electrolytic layer. The electron moves to the air electrode 12 through an external circuit. When oxygen meets the hydrogen ion at the air electrode 12, water is generated. A chemical equation related to the matter described above is shown in the following chemical formula (1).

fuel electrode: H₂→2H⁺+2e^{-air electrode:} ½O₂+2H⁺+2e⁻→H₂O overall reaction: H₂+½O₂→H₂O (1)

Hydrogen and air should be supplied to the MEA 10 in order to generate electrical energy. In FIG. 1, since the stack of the embodiment of the present invention has a flat plate shape and uses a single layer stack, it is possible to use the oxygen in the air by opening the side of the air electrode 12 and allowing the air electrode 12 to contact with the air, instead of forcibly supplying the oxygen. Such a structure requires neither a separate device for removing the water because the water generated on the side of the air electrode 12 evaporates into the air as described in the chemical formula (1), nor a forced flow method excessively supplying the hydrogen. That is, even though a dead-end channel is applied, there is no necessity of removing the water.

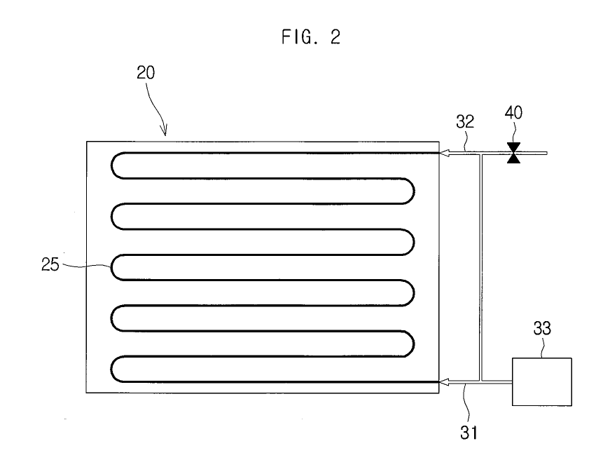

A separator 20 having a channel formed therein is placed on the side of the fuel electrode 16, which allows the hydrogen to be evenly supplied. FIG. 2 is a plan view showing a separator 20 of a fuel cell system according to an embodiment of the present invention. The separator 20 is a plate-shaped member in which a channel 25 having an open part adjacent to the fuel electrode is formed. When the hydrogen is supplied to the channel 25, the hydrogen is supplied to the fuel electrode along the channel 25. The channel 25 can have various shapes including a serpentine shape as shown in FIG. 2.

A hydrogen supply device supplies hydrogen to the fuel electrode 16 and includes a first pipe 31, a second pipe 32, a manifolder 33 and a hydrogen storage tank 35.

The hydrogen storage tank 35 is one of the fuel supply devices that are used for storing the hydrogen in order to supply the hydrogen to the stack. A hydrogen storage method includes a method of storing the hydrogen by use of a compressed tank, a liquefied hydrogen storage technology using a very low temperature, a method of storing hydrogen in the material such as carbon nanotube (CNT), and a method of storing hydrogen by using metal hydride such as metal powder, having a property of absorbing the hydrogen.

Since high pressure is applied to the hydrogen in the hydrogen storage tank 35, the manifolder 33 is interposed between the hydrogen storage tank 35 and the fuel cell stack, so that hydrogen supply to the stack can be controlled by adjusting the pressure of the hydrogen.

When hydrogen is supplied to the fuel cell stack only in one direction, the hydrogen can be supplied only through the first pipe 31. But, in order to more evenly supply the hydrogen, it is possible to supply the hydrogen through the first pipe 31 and the second pipe 32 in both directions. In FIGS. 1 and 2, hydrogen can be supplied to both sides of the separator 20. There is no extra hydrogen outlet in the system, such that all the supplied hydrogen can be consumed in the fuel electrode 16.

However, when internal pressure is unexpectedly increased, for example, thermal expansion caused by temperature rise, etc., the dead-end channel may be damaged. Therefore, a relief valve 40 can be formed on one side of the pipe in order to prevent such a danger. In FIGS. 1 and 2, while the relief valve 40 is formed on a position adjacent to the second pipe, the position is not limited.

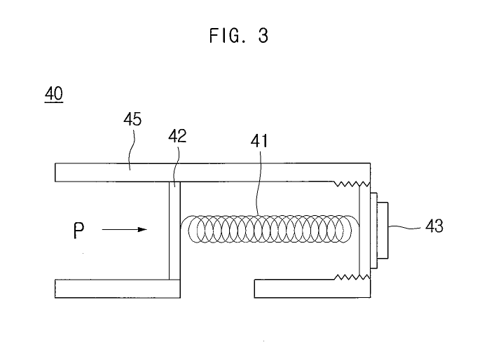

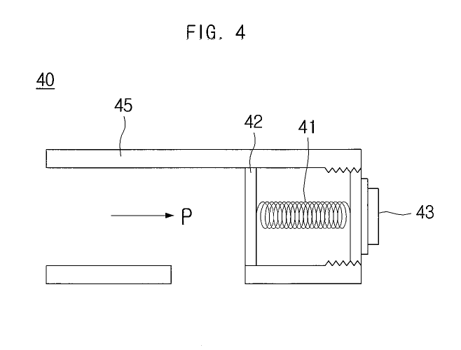

FIGS. 3 and 4 are conceptual diagrams showing the operation of a relief valve 40 of the fuel cell system according to an embodiment of the present invention. Illustrated are a main body 45, a spring 41, an adjusting screw 43 and a piston 42.

A main body 45 constituting the trunk of the relief valve 40 is connected to the hydrogen supply pipe through one side of the relief valve 40 (on the left side of the relief valve 40 in FIGS. 3 and 4). A spring 41 is expanded and contracted according to a pressure applied to a piston 42. The amount of the pressure that the spring 41 can endure can be adjusted by an adjusting screw 43. FIG. 4 shows a state that the spring 41 of the relief valve 40 is contracted. When the pressure (denoted by ‘P’) inside the pipe is increased, the pressure applied to the piston 42 is increased, so that the spring 41 is contracted. Accordingly, one side of the valve is opened and the pressure inside the pipe can be reduced as shown in FIG. 4. When the pressure inside the pipe becomes low, the piston 42 returns to the origin point and the relief valve 40 is closed as shown in FIG. 3.

In such a structure, since only when excessive pressure is applied, the pressure inside the pipe is reduced by opening the relief valve 40 by mechanically sensing the pressure in order to prevent the separator from being damaged. As a result, and extra sensor 20 is not required. Since the problem of the dead-end channel is solved, it is possible to use all the hydrogen supplied by use of the dead-end channel.

While certain embodiment of the present invention has been described, it shall be understood by those skilled in the art that various changes and modification in forms and details may be made without departing from the spirit and scope of the present invention as defined by the appended claims.

Numerous embodiments other than embodiments described above are included within the scope of the present invention.

What is claimed is:

1. A fuel cell system comprising:
a membrane electrode assembly comprising a fuel electrode, an air electrode, and an electrolyte layer interposed between the fuel electrode and the air electrode;
a separator comprising a channel that is adjacent to the fuel electrode and is provided for supplying hydrogen to the fuel electrode;
a hydrogen supply device supplying hydrogen to the channel; and
a relief valve formed on the channel and configured to control pressure of the channel.

2. The fuel cell system of claim 1, wherein the hydrogen supply device comprises:
a hydrogen storage tank configured to store hydrogen; and
a manifolder configured to control pressure of hydrogen supplied from the hydrogen storage tank.

3. The fuel cell system of claim 1, wherein the hydrogen supply device supplies hydrogen to one end of the channel and the other end of the channel, and comprises a first pipe connected to one end of the channel and a second pipe connected to the other end of the channel.

4. The fuel cell system of claim 1, wherein the relief valve comprises a piston that is mechanically opened when the pressure of the channel increases.
